(19) United States
(12) Patent Application Publication
(10) Pub. No.: US 2005/0084659 A1
(43) Pub. Date: Apr. 21, 2005

(54) Vehicle windshield head-up display

(75) Inventor: Ralf Dunkel, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: General Atomics, San Diego, CA (US)

(21) Appl. No.: 10/690,180

(22) Filed: Oct. 20, 2003

(51) Int. Cl. B32B 3/00

(52) U.S. Cl. 428/209

(57) ABSTRACT

A head-up display (HUD) is incorporated within a windshield of a motor vehicle at a location through which the operator's field of vision onto the highway ahead must pass. The TOLED is formed of transparent materials and laminated, along with a polymeric interlayer, between two plies of glass; a pair of elongated conductors electrically connect the electrodes of the TOLED to an edge of the windshield. Upon the receipt of signals from a controller, light is created within the plies of the windshield to immediately convey a HUD to the operator without the need for his or her vision to leave the highway ahead.

### FIELD OF THE INVENTION

This invention relates to a head-up display incorporated within a vehicle windshield and more particularly to a vehicle windshield having inner and outer plies of glass wherein a transparent organic light emitting device (TOLED) is located between such plies so as to be within the field of vision of the vehicle operator.

### BACKGROUND OF THE INVENTION

For over half a century, there have been proposals to place information of value to a vehicle operator in the field of vision of the operator so that the operator will not be required to glance away to read such information, for example, see U.S. Pat. No. 2,264,044 (1941). Attempts to provide such satisfactory head-up devices, often referred to HUDs, have taken a variety of different forms.

A 1989 patent (Pat. No. 4,842,389) taught the incorporation of a flexible hologram within the two plies of a windshield. When incorporated in an automobile, information is projected using an optical lens projection system and a halogen lamp mounted below the dashboard of the automobile. A 1991 published international application (No. WO91/06031) taught the inclusion of a interlayer having a predetermined wedge angle, that is disposed between outboard and inboard sheets of glass. Again, a optical projection system is used to project the information from a remote location onto the windshield. A similar projection system using a wedged windshield is illustrated in U.S. Pat. No. 5,013,134. U.S. Pat. No. 6,091,376 teaches forming a touch panel for a mobile telephone on the front windshield wherein an optical system using a pair of mirrors is utilized. More recently, U.S. published application No. 2002/0120916 (Aug. 29, 2002) discloses a head-up display (HUD) system which includes fluorescent or phosphorescent materials and a projection assembly utilizing an electromagnetic radiation source; the system may be incorporated in an automotive windshield between two plies of glass wherein a region of flourescent material would be located in the field of vision of the operator to be used in combination with a head-up data projection system employing the electromagnetic radiation source. Still more recent is published international application WO/03020545 (13 Mar. 2003) which couples a flexible display screen to the windshield, for example at the interface between the windshield and dashboard of an automobile. The display system may be an OLED that is held in a frame or mounted otherwise. It is disclosed that the display screen itself should be flexible and have a luminescent display so that it can be used to conform to the curved shape of the interior of the vehicle. For example, the OLED screen may be received in a cavity molded within a substrate wherein it will be housed. Objects exterior of the vehicle are visible through the flexible display screen and the substrate whenever the flexible display screen is not being activated.

Although various of these systems have certain advantages, none of them has been widely successful, and accordingly, improvements have been sought which do not require independent projection systems and which deviate very little from traditional automotive design, so as to obviate any need for significant automotive design changes.

### SUMMARY OF THE INVENTION

It has now been found that a TOLED can be effectively incorporated within an otherwise standard vehicle windshield or the like which, in its unactivated form, although located in the operator's field of vision, will not be noticed because of its totally transparent characteristics. When activated, the light that is emitted is generated within the two plies of the windshield itself. As a result of its location, it is reasonably secure from potential damage and protected from deterioration by the plies themselves, particularly when those plies are made of glass as is normally the case in automotive windshields today. Electrical connections to supply voltage to the various light-emitting pixels of the TOLED are elongated and extend from an edge of the windshield to the location of the TOLED; they are made of transparent, electrically conducting material such as indium tinoxide (ITO) or polyethylenethioxythiophene (PEDOT).

In one particular aspect, the invention provides a vehicle display device, which device comprises an optically transparent laminated windshield having inner and outer juxtaposed plies, an interlayer disposed between said plies, said interlayer being optically transparent and adhering to said plies so as to join them in a laminated construction, a TOLED located so as to be in the field of vision of an operator of the vehicle and being likewise disposed between said plies, and transparent conductor means leading to said TOLED for activating said TOLED to generate light within said plies of the windshield to provide a head-up message or the like to such operator.

In one particular aspect, the invention provides a vehicle display device, which device comprises an optically transparent laminated windshield having inner and outer juxtaposed plies, an interlayer disposed between said plies, said interlayer being optically transparent and adhering to said plies so as to join them in a laminated construction, a TOLED which is located so as to be in the field of vision of an operator of the vehicle and which is likewise disposed between said plies, and transparent conductor means leading to said TOLED for activating said TOLED to generate light within said plies of the windshield to provide a head-up message or the like in the field of vision of such operator so the operator's eyes may always remain on the road ahead.

In another particular aspect, the invention provides a motor vehicle windshield which comprises inner and outer plies of glass shaped to close a window opening in the front of an a motor vehicle, a polymeric interlayer of transparent material securing said plies to each other, a thin transparent display device located in juxtaposition with said interlayer in a generally central location between an upper edge and a lower edge of said windshield, which display device contains a plurality of pixels that emit light when activated, transparent conductor means extending from said transparent display device to an edge of the windshield, and means for connecting said conductor means to an electronic unit for sending signals to said display device to emit light and thereby create a head-up display at a location generally centrally of the motor vehicle operator's field of vision through the windshield toward the road ahead.

### BRIEF DESCRIPTION OF THE DRAWINGS

FIG. 1 is a schematic view of an automobile windshield section showing in dotted outline the location of a transparent OLED display device and transparent conductors leading to the edge of the windshield.

FIG. 1A is an enlarged fragmentary view of the TOLED of FIG. 1.

FIG. 2 is schematic exploded cross-section view enlarged in size of the windshield of FIG. 1, taken through the OLED display device itself.

FIG. 3 is a schematic view showing a preferred method of making a transparent OLED for use as a head-up display in an automotive windshield by depositing thin layers upon two separate films of a polymer such as polycarbonate.

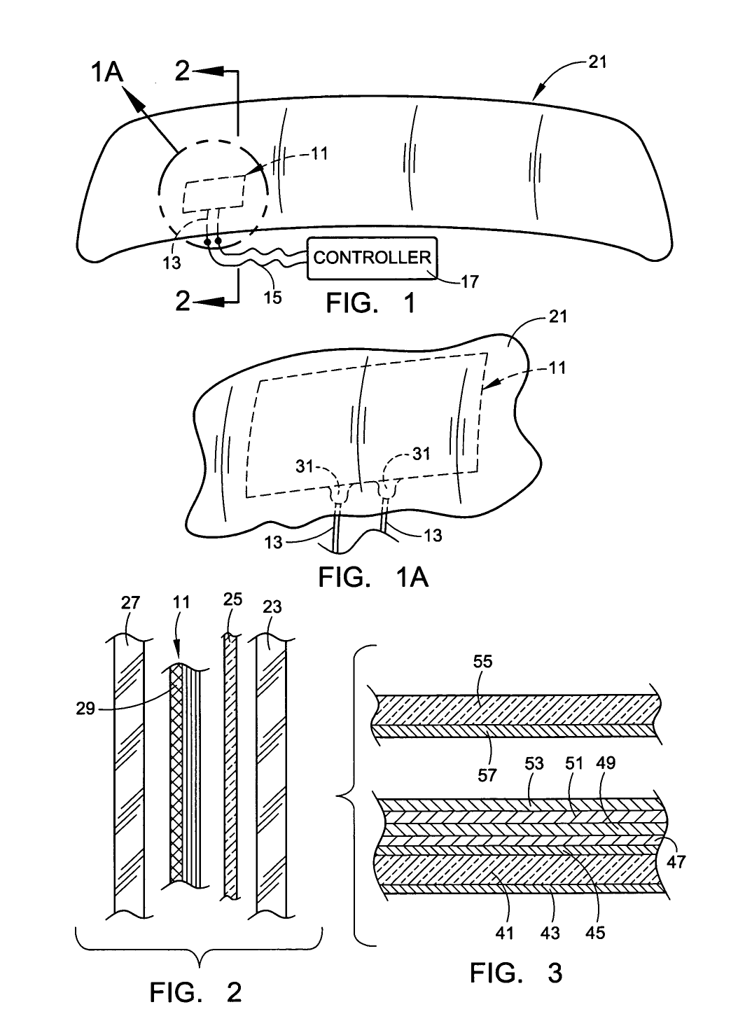

### DETAILED DESCRIPTION OF THE PREFERRED EMBODIMENTS

Very briefly, the invention provides a light generating and emitting device which is transparent when not activated and which is constructed for lamination between the inner and outer plies of a motor vehicle window, particularly a windshield. The display device is preferably a transparent OLED (TOLED) which is located directly in the field of vision of the operator of the motor vehicle, so the operator will instantly be aware of the head-up message that would be generated on the display device. A pair of conductors leading from the TOLED provide an electrical connection thereto, extending to one edge of the windshield, preferably the lower or bottom edge, where wire bonding makes a connection to the vehicle electrical system, e.g. an electronic unit for sending signals for a head-up display. Such conductors are also transparent. The connection may be to a controller located on or below the dashboard, for example, which is itself electrically connected to the operating system of the motor vehicle. This allows the motor vehicle computer control and/or the guidance and navigation system to generate head-up messages, for example, right/left turn arrows or other of the general type that are presently displayed on an overhead console located near the roof of many present day vehicles. By displaying these on the windshield, instead of having the operator's eyes leave the road to read the message on such a roof-mounted display panel, the head-up message is presented directly in the operator's field of vision and does not significantly distract from his continued viewing of the road ahead.

Generally, a window or windshield for a motor vehicle is a laminated structure which includes an outboard ply of glass, a transparent interlayer and an inboard ply or sheet of glass. The interlayer is disposed and juxtaposed with the inboard surface of the outboard glass sheet and the outboard surface of the inboard glass sheet, and it is adhered to both. The interlayer will be made of plastic material, preferably polyvinyl butyral, and may be differentially stretched to match any curvature in the associated glass sheet. Methods for such lamination are disclosed in U.S. Pat. Nos. 3,231,461 and 4,554,713. Other interlayer materials that have been used include plasticized polyvinyl chloride and even multi-layered materials that include a thin layer of polyethylene terephthalate (PET). As previously mentioned, the preferred interlayer is one of polyvinyl butyral, and it may have a thickness of about 1 mm.

The interlayer is separately produced and then positioned between the two plies of glass or the like that are used to create the motor vehicle window. The TOLED might be positioned in contact with either the inboard or outboard surface of the transparent interlayer; however as between these two alternatives, positioning between the inboard surface of the interlayer and the inboard ply of glass or the like is preferred. In this respect, the TOLED may be made with a coating of pressure sensitive adhesive and optionally a release layer on its inboard surface so that, as part of the manufacturing process, the TOLED could be affixed to the outboard surface of the inboard glass ply of the windshield before it is united with the interlayer and the outboard glass ply. A similar but opposite arrangement might be used if the TOLED were to be disposed between the interlayer and the outboard glass ply. A further alternative is to use a split interlayer and locate the TOLED between the two thin polymeric films that would make-up the interlayer. For example, two 0.5 mm films of polyvinyl butyral might be employed instead of a one millimeter layer, and the TOLED could be simply positioned so it is sandwiched at the desired location between these two films before the lamination process.

Transparent OLED materials are available from vendors such as Philips, DuPont, Pioneer, Covion and Kodak. Generally, present day OLEDs are built on a transparent substrate and include an anode, a hole transport layer, a polymeric light-emitting layer, an electron transport layer, and a metal cathode. Because various of these materials are susceptible to degradation by exposure to moisture and/or oxygen, environmental barriers are placed on one or both surfaces as necessary. A general description of OLEDs and some excellent barrier materials appears in international application WO 02/091,064 (published 14 Nov. 2002), the disclosure of which is incorporated herein by reference. For a TOLED useful in the present invention, all of these elements need to be transparent.

Frequently, the anode electrode has been made of inorganic ITO which has acceptable optical transparency at thicknesses of between about 300 and 2000 Angstroms; however, other materials that such as conducting polyaniline, polypyrrole and polythiophene may also be employed. These conducting materials may also be used as the conductor means in the present application, which may be a pair of parallel conductors that extend from the TOLED to one edge, preferably the bottom edge, of the window or windshield. These conductors can be made integral with one or both of the electrodes of the TOLED so it is produced as an integral unit. However, for manufacturing efficiency, it may be preferable to manufacture the TOLED separately from the conductor means. For example, such a pair of essentially parallel, thin, planar conductors deposited on a thin polymeric film of PET or polycarbonate, about 0.1-0.2 mm thick, might be manufactured and then united with the TOLED, with one of the parallel conductors being placed in contact with the anode electrode and the other parallel transparent conductor being placed in the contact with the cathode electrode. For example, if the TOLED were to be located on the outboard surface of the inboard glass ply, it could be first positioned centrally in the field of vision of the operator. If it were formed with the anode and cathode having extensions spaced apart from each other, the proximal ends of parallel, thin, flat conductors might be interconnected therewith, with their distal ends extending to one edge of the windshield. In this respect, a suitable adhesive could be used, or the conductor unit might also be formed with pressure-sensitive adhesive on one surface.

One exemplary method of construction of the TOLED would be by providing a thin film of polycarbonate (PC), about 150 microns thick, and first coating one surface with a ceramic barrier layer of aluminum oxide having a thickness of about 300 to 800 Angstroms. Next, the opposite surface of the polycarbonate film is used as a substrate upon which to deposit a TOLED. First, a transparent anode electrode is deposited using ITO or the like. This is followed by the deposition of a hole transport layer then a polymeric light-emitting layer and then an electron transport layer. Finally, a transparent cathode layer, which may be made of ITO, PEDOT, magnesium fluoride, lithium fluoride or any other suitable material, as disclosed in U.S. Pat. No. 6,525,466, is deposited. The cathode layer may be 100-300 angstroms thick, and to it is laminated a second film of polycarbonate having a thin layer of acrylic resin, e.g. about 1 micron thick, so that the acrylic resin is juxtaposed with the cathode material. If the TOLED is to be used fairly quickly, it is likely that no further environmental barrier would be needed, as once the TOLED is laminated between two plies of glass or the like in the windshield of a car, they will provide inherent resistance to the transmission of the water vapor and/or oxygen which would potentially degrade the TOLED. However, if it is likely that some time may pass before the TOLED is incorporated in a motor vehicle window, it may be desirable to provide additional barrier materials at one or both surfaces of the TOLED. For example, the barrier layer might be coated with one micron thick coating of a suitable polymer, such as an acrylic polymer or an organiosilicon polymer, as disclosed for example in U.S. Pat. No. 5,718,967 and Pat. No. 6,203,898. Similarly, the polycarbonate film used to for lamination atop the cathode might also be provided on its other surface with a layer of ceramic barrier material, e.g., aluminum oxide or silicon oxide, and then covered with a thin protective layer of polymer, as mentioned just above, to protect its integrity.

In constructing an illustrative device, a pair of inboard and outboard plies of glass designed for an automotive windshield are provided, and a TOLED having pressure sensitive adhesive layer on its inboard surface is provided. A release sheet is removed to uncover this adhesive, and the TOLED is placed generally centrally on the outboard surface of the inboard glass ply of the windshield in the region where it would be directly in the vision of the driver, for example, so that its upper edge extends to a level about midway between the upper and lower edges of the windshield. A separate conductor unit having a pair of thin flat conductors on a film of PET or PC, having pressure-sensitive adhesive on its surface upon which the conductors are carried, is then attached to the outboard surface of the inboard glass ply. This makes connections to short protruding contacts of the anode and cathode respectively, via the proximal ends of the pair of conductors of the conductor unit. The distal end of the unit extends to the lower edge of the windshield where it is wire-bonded to a wiring harness from a simple electronic control unit designed to receive signals from the computer operating system for the engine, from the various gauges, and from a guidance/navigation system provided in the motor vehicle. Testing shows that, when the TOLED is not activated, it is essentially transparent and in no way interferes with the normal vision of the motor vehicle operator. However, once signals are sent to the TOLED from the control unit, the pixels in the TOLED create a head-up display that presents a message that is immediately conveyed to the operator in a manner that does not cause him or her to shift vision from the highway ahead to read the message.

Although the invention has been described with regard to certain preferred embodiments which constitute the best mode known at the present time for carrying out the invention, it should be understood that various changes and modifications might be made without departing from the scope of the invention which is defined in the claims appended hereto. The disclosures of all U.S. patents and published patent applications mentioned herein are expressly incorporated herein by reference.

Particular features of the invention are emphasized in the claims that follow.

1. A vehicle display device, which device comprises:
an optically transparent laminated windshield having inner and outer juxtaposed plies,
an interlayer disposed between said plies,
said interlayer being optically transparent and adhering to said plies so as to join them in a laminated construction,
a TOLED which is located so as to be in the field of vision of an operator of the vehicle and which is likewise disposed between said plies, and
transparent conductor means leading to said TOLED for activating said TOLED to generate light within said plies of the windshield to provide a head-up message or the like in the field of vision of such operator so the operator's eyes may always remain on the road ahead.

2. The display device of claim 1 wherein said interlayer includes inner and outer polymeric layers with said TOLED being sandwiched therebetween.

3. The display device of claim I wherein said TOLED carries a layer of pressure sensitive adhesive on one surface and is located between said interlayer and one said ply.

4. The display device of claim 3 wherein said plies are made of glass.

5. The display device of claim 4 wherein said TOLED is provided with transparent environmental barriers to moisture and/or oxygen to retain its integrity until such time as it is laminated between said plies.

6. The display device of claim 1 wherein the TOLED comprises a plurality of layers, including (a) an electron transporting layer, (b) a polymeric light-emitting layer, (c) a hole transporting layer, (d) a pair of flanking electrode layers, and (e) a pair of films of polycarbonate which in turn flank said electrodes, all of which layers and films are optically transparent.

7. The display device in accordance of claim 6 wherein said polycarbonate films each have a thickness between about 0.1 and about 0.2 mm.

8. In accordance with claim 7 wherein at least one of said polycarbonate films is coated with a layer of ceramic barrier material.

9. The display device of the claim 8 wherein one of said polycarbonate films is coated with a layer of an acrylic polymer.

10. The display device of claim 1 wherein said conductor means includes a pair of conductors formed of transparent ITO.

11. The display device according to claim 10 wherein the conductors are elongated and extend from the TOLED to an edge of the windshield.

12. A motor vehicle windshield which comprises:
inner and outer plies of glass shaped to close a window opening in the front of an a motor vehicle,
a polymeric interlayer of transparent material securing said plies to each other,
a thin transparent display device located in juxtaposition with said interlayer in a generally central location between an upper edge and a lower edge of said windshield, which display device contains a plurality of pixels that emit light when activated,
transparent conductor means extending from said transparent display device to an edge of the windshield, and
means for connecting said conductor means to an electronic unit for sending signals to said display device to emit light and thereby create a head-up display at a location generally centrally of the motor vehicle operator's field of vision through the windshield toward the road ahead.

13. A method for presenting a head-up display to the operator of a motor vehicle in a manner so the operator's eyes never need to leave the road ahead, which method comprises:
providing a thin transparent display device at a location between inner and outer plies of glass shaped to constitute a motor vehicle windshield at a generally central location between an upper edge and a lower edge of said windshield, which display device contains a plurality of pixels that emit light when activated,
connecting the display device via transparent conductor means extending from said transparent display device to an edge of the windshield,
connecting said conductor means to an electronic unit, and
sending signals from said electronic to said display device to cause said display device to emit light and thereby create a head-up display at a location generally centrally of the motor vehicle operator's field of vision through the windshield toward the road ahead.
